(19) United States
(12) Patent Application Publication
(10) Pub. No.: US 2008/0174274 A1
(43) Pub. Date: Jul. 24, 2008

(54) BATTERY UNIT

(75) Inventors: Yuki KOSAKA, Yokohama-shi (JP); Susumu KOMIYAMA, Tokyo (JP); Kazuhiro TAKEDA, Yokosuka-shi (JP)

Correspondence Address: GLOBAL IP COUNSELORS, LLP, 1233 20TH STREET, NW, SUITE 700, WASHINGTON, DC, 20036-2680, US

(73) Assignee: NISSAN MOTOR CO., LTD., Yokohama (JP)

(21) Appl. No.: 11/969,955

(22) Filed: Jan. 7, 2008

(30) Foreign Application Priority Data
Jan. 18, 2007 (JP) 2007-009357

(51) Int. Cl. H02J 7/00

(52) U.S. Cl. 320/117

(57) ABSTRACT

A battery unit has positive and negative terminals, a pair of battery modules, three switch modules, a bypass line and a controller. A first battery module is connected to the positive and negative terminals. The second battery module is connected in parallel with the first battery module. Each battery module includes a battery and a reactor connected together in series. The first switch module extends between the negative terminal and a negative electrode side of the first battery module. The second switch module extends between positive electrode sides of the first and second battery modules. The bypass line connects a point lying between the first battery module and the first switch module to a point lying between the second battery module and the second switch module. The third switch module is arranged in the bypass line. The controller controls an on-off state of each of the switch modules.

### CROSS-REFERENCE TO RELATED APPLICATIONS

This application claims priority to Japanese Patent Application No. 2007-009357, filed on Jan. 18, 2007. The entire disclosure of Japanese Patent Application No. 2007-009357 is hereby incorporated herein by reference.

### BACKGROUND OF THE INVENTION

1. Field of the Invention

The present invention generally relates to a battery unit. More specifically, the present invention relates to a battery unit including a plurality of battery modules or blocks in which a connection state of the battery blocks can be selectively switched between a series connection and a parallel connection to vary the output voltage from the battery modules or blocks.

2. Background Information

An electric vehicle typically has a battery unit with a plurality of battery modules electrically connected to a motor that serves to drive the vehicle. For example, Japanese Laid-Open Patent Publication No. 5-236608 discloses an example of a conventional electric automobile with a motor and a vehicle electric power supply system with a battery unit having a plurality of battery modules or blocks electrically connected to the motor. Such a conventional vehicle power supply system switches a connection state of the battery unit between a state in which the battery modules are connected in series and a state in which the battery modules are connected in parallel. The output voltage of the battery unit is changed by switching between the series connection state and the parallel connection state. More specifically, in cases where the required voltage is relatively small, the output voltage is reduced by connecting the battery blocks in parallel. Meanwhile, in cases where the required voltage is relatively large, the output voltage from the battery blocks is increased by connecting the battery blocks in series. Therefore, the efficiency of the system is increased.

In view of the above, it will be apparent to those skilled in the art from this disclosure that there exists a need for an improved battery unit. This invention addresses this need in the art as well as other needs, which will become apparent to those skilled in the art from this disclosure.

### SUMMARY OF THE INVENTION

It has been discovered that when the above described battery is charged with an external power source, it is necessary to use a charging apparatus having a complex structure that includes switches, reactors, and lines for passing flywheel currents of the reactors.

In view of this aforementioned problem of the above described conventional technology, one object of the present invention to provide a battery unit that does not require a complex charging apparatus and that gradually changes the electric current without an occurrence of a so-called surge current.

In order to achieve the above object of the present invention, a battery unit is provided that basically comprise a positive electrode terminal, a negative electrode terminal, a first battery module, a second battery module, a first switch module, a second switch module, a bypass line, a third switch module and a controller. The first battery module is connected to the positive and negative electrode terminals. The first battery module includes a first battery and a first reactor connected together in series. The second battery module is connected in parallel with the first battery module. The second battery module includes a second battery and a second reactor connected together in series. The first switch module is arranged between the negative electrode terminal and a negative electrode side of the first battery module. The second switch module is arranged between a positive electrode side of the first battery module and a positive electrode side of the second battery module. The bypass line connects a point lying between the first battery module and the first switch module to a point lying between the second battery module and the second switch module. The third switch module is arranged in the bypass line. The controller is operatively arranged to control an on-off state of each of the first, second and third switch modules.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a simplified circuit diagram of a battery unit in accordance with one embodiment of the present invention;

FIG. 2 is a simplified circuit diagram illustrating a state in which the battery unit is being charged while installed in a vehicle in accordance with the illustrated embodiment;

FIG. 3A is a first control flowchart showing the control executed by the controller for charging the first battery module using an external electric power source;

FIG. 3B is a second control flowchart showing the control executed by the controller for charging the second battery module using an external electric power source;

FIG. 4 is a time chart showing the states of the charging current and the switches when the flowcharts of FIGS. 3A and 3B are executed;

FIG. 5A is a simplified circuit diagram illustrating the flow of current that occurs when the charging control is executed with respect to the first battery module;

FIG. 5B is a simplified circuit diagram illustrating the flow of current that occurs when the charging control is executed with respect to the first battery module;

FIG. 6A is a simplified circuit diagram illustrating the flow of current that occurs when the charging control is executed with respect to the second battery module;

FIG. 6B is a simplified circuit diagram illustrating the flow of current that occurs when the charging control is executed with respect to the second battery module;

FIG. 7A is a simplified circuit diagram showing the flow of current that occurs when control is executed to charge both the first and second battery modules using an external electric power source;

FIG. 7B is a simplified circuit diagram showing the flow of current that occurs when control is executed to charge both the first and second battery modules using an external electric power source;

FIG. 8A is simplified circuit diagram illustrating the flow of current that occurs when a voltage variation correction control in accordance with the present invention is executed in order to correct voltage variation among the battery modules of the battery unit;

FIG. 8B is simplified circuit diagram illustrating the flow of current that occurs when a voltage variation correction control in accordance with the present invention is executed in order to correct voltage variation among the battery modules of the battery unit; and

FIG. 9 is a simplified circuit diagram of a battery unit having three battery modules in accordance with another embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

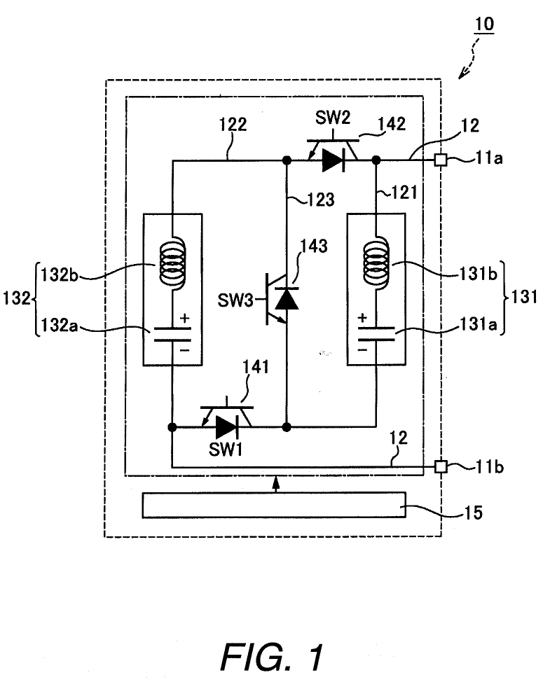

Referring initially to FIG. 1, a simplified circuit diagram of a battery unit 10 is illustrated in accordance with one embodiment of the present invention. Basically, the battery unit 10 has a first positive electrode terminal 11a, a second negative electrode terminal 11b, an electrical line 12, a controller 15, a first battery module 131, a second battery module 132, a first switch module 141, a second switch module 142 and a third switch module 143. The terminals 11a and 11b are configured and arranged for connecting an external device thereto. The electrical line 12 electrically connects the terminals 11a and 11b via the first and second battery modules 131 and 132 as seen in FIG. 1. In particular, at an intermediate point of the electrical line 12, the electrical line 12 branches into a first line 121 with the first battery module 131 and a second line 122 with the second battery module 132. The battery unit 10 also includes a bypass line 123 that connects a point of the first line 121 lying between the first battery module 131 and the first switch module 141 to a point of the second line 122 lying between the second battery module 132 and the second switch module 142.

In the illustrated embodiment of FIG. 1, an internal electric current of the battery unit 10 can be controlled so as to charge the first and second battery modules 131 and 132, and the bypass line 123 forms a flywheel circuit so that electric power stored (the current) of a reactor can be passed through the bypass line 123. As a result, the charging apparatus of the battery unit 10 can be simplified. Moreover, internal electric current of the battery unit 10 gradually changes the current without surge currents occurring.

The first battery module 131 is arranged in the first line 121. The first battery module 131 includes a battery 131a and a reactor 131b. The battery 131a and the reactor 131b are connected together in series. As shown in FIG. 1, an upper electrode of the battery 131a is a positive electrode and a lower electrode is a negative electrode. The battery 131a is, for example, a storage battery or a capacitor storing electric power. The reactor 131b is, for example, a coil or a capacitor having a reactor component. The reactor 131b is configured and arranged to suppress or minimize overcurrents that might occur.

The second battery module 132 is arranged in the second line 122. The second battery module 132 is connected in parallel with the first battery module 131. The second battery module 132 includes a battery 132a and a reactor 132b. The battery 132a and the reactor 132b are connected together in series. As shown in FIG. 1, an upper electrode of the battery 132a is a positive electrode and a lower electrode is a negative electrode. The battery 132a is, for example, a storage battery or a capacitor storing electric power. The reactor 132b is, for example, a coil or a capacitor having a reactor component. The reactor 132b is configured and arranged to suppress or minimize overcurrents that might occur.

In the illustrated embodiment, for example, the first switch module 141 is a semiconductor switch including a first diode and a first transistor. The diode permits a flow of electric current from a negative electrode side of the second battery module 132 to the negative electrode side of the first battery module 131, but blocks a flow of electric current from the negative electrode side of the first battery module 131 to the negative electrode side of the second battery module 132. The transistor is a current amplifying element. In FIG. 1, the transistor is exemplified as an NPN-type transistor. When a base current exists, a collector current flows from the negative electrode side of the first battery module 131 to the negative electrode side of the second battery module 132. Hereinafter, a state in which a base current is flowing to a transistor will be referred to as a state in which the switch is “on”.

In the illustrated embodiment, for example, the second switch module 142 is a semiconductor switch including a second diode and a second transistor. The second diode of the second switch module 142 permits a flow of electric current from the positive electrode side of the second battery module 132 to the positive electrode side of the first battery module 131, but blocks a flow of electric current from the positive electrode side of the first battery module 131 to the positive electrode side of the second battery module 132. The second transistor of the second switch module 142 is arranged such that when a base current exists, a collector current flows from the positive electrode side of the first battery module 131 to the positive electrode side of the second battery module 132.

The third switch module 143 is arranged in the bypass line 123. In the illustrated embodiment, for example, the third switch module 143 is a third semiconductor switch including a third diode and a third transistor. The diode of the third switch module permits a flow of electric current from the negative electrode side of the first battery module 131 to the positive electrode side of the second battery module 132, but blocks a flow of electric current from the positive electrode side of the second battery module 132 to the negative electrode side of the first battery module 131. The transistor of the third switch module 143 is arranged such that when a base current exists, a collector current flows from the positive electrode side of the second battery module 132 to the negative electrode side of the first battery module 131. Alternatively, the third switch module 143 can be a two-way semiconductor switch, in which case the diode is not needed.

The controller 15 controls the base currents supplied to each of the transistors of the switch modules 141, 142 and 143, and thereby, controls the on-off state of each of the switch modules 141, 142 and 143. The controller 15 is preferably a microcomputer having a central processing unit (CPU), a read only memory (ROM), a random access memory (RAM), and an input/output interface (I/O interface). It is also acceptable for the controller 15 to be made up of a plurality of microcomputers.

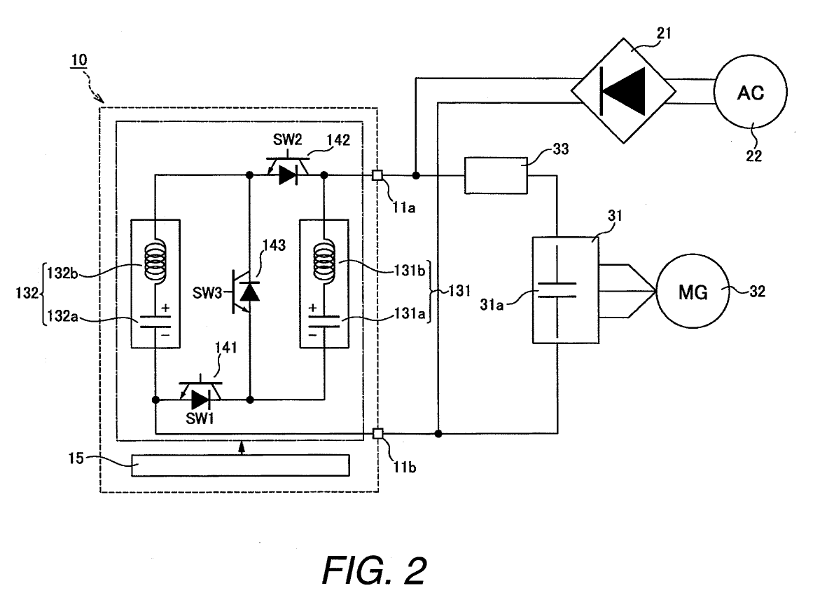

FIG. 2 is illustrates a state in which the battery unit is being charged while installed in a vehicle. The battery unit 10 is connected to an external electric power source 22 (a commercially available power source or other power source) through a rectifier 21, and the battery unit 10 is charged by the external electric power source 22. It is also acceptable for the rectifier 21 to be provided in the battery unit 10 or in the external power source 22.

The battery unit 10 is also connected to a motor generator 32 through an inverter 31 and a circuit breaker or contactor 33. The battery unit 10 is configured both to drive the vehicle by supplying electric power to the motor generator 32 and to be charged with electric power generated by the motor generator 32. The inverter 31 includes a smoothing capacitor 31a at the input end thereof. The circuit breaker 33 is a device that functions to connect and disconnect an electric power supply line. Thus, the circuit breaker 3 is configured and arranged to cut off the power supply line. Generally, a mechanical relay or the like is used as the circuit breaker 33.

As seen from the circuit configuration, the battery unit 10 can be switched between a state in which the first and second battery modules 131 and 132 are connected in parallel and a state in which the same are connected in series and can deliver or receive electric power while in either of these connection states. The controller 15 controls the switching of the connection state in a known manner by controlling the switch modules 141, 142 and 143.

As a first working example of this embodiment, a charging method (first charging method) will now be explained which is used when the charging voltage applied to the terminals 11a and 11b from the external power source 22 is set to be higher than the voltage of the battery module 131 or 132 being charged and lower than the voltage across the first and second battery modules 131 and 132 connected together in series. An example of such a case is when the voltage of the external power source 22 is 200 V, the voltage of the first battery module 131 is 180 V, and the voltage of the second battery module 132 is 180 V.

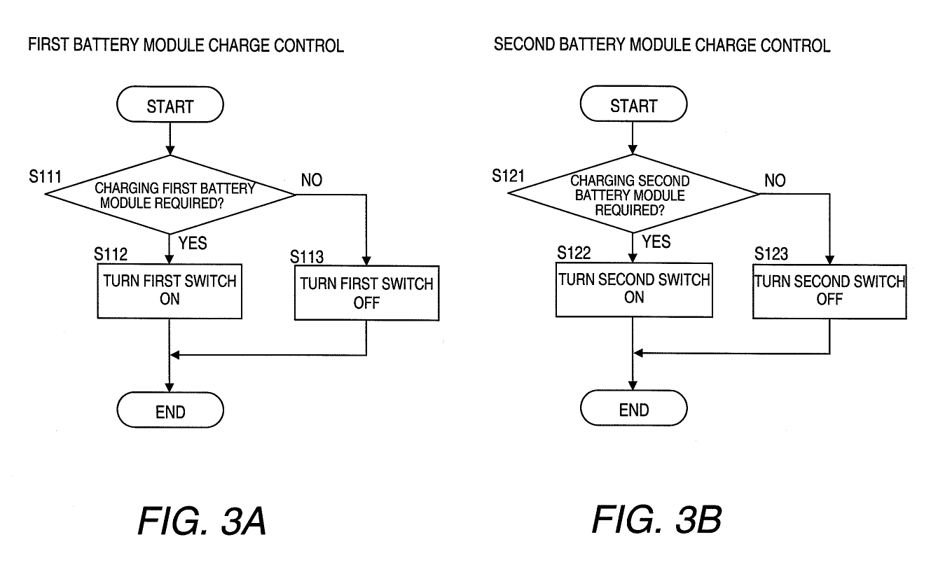

FIGS. 3A and 3B are control flowcharts showing the control executed by the controller 15 when an external power source 22 is used to charge the battery modules 131 and 132, respectively and the charging voltage applied to the terminals 11a and 11b from the external power source 22 is set to be higher than the voltage of the battery modules 131 and 132 being charged and lower than the voltage across the first and second battery modules 131 and 132 connected together in series. The controller 15 repeatedly executes this control processing once per prescribed amount of time (e.g., every 10 milliseconds).

When the external power source 22 is used to charge the first battery module 131, the controller 15 executes the flowchart of FIG. 3A. The voltage applied to the terminals 11a and 11b is higher than the voltage of the first battery module 131 and lower than the voltage across the first and second battery modules 131 and 132 connected together in series.

In step S111, the controller 15 determines if it is necessary to charge the first battery module 131. This determination is accomplished by determining if a target charging current is not reached. If the target charging current is not reached, then charging is necessary. If the target charging current is reached, then the controller 15 determines that charging is not necessary.

If charging is necessary, then the controller 15 proceeds to step S112. In step S112, the controller 15 turns the first switch module 141 on (switch-on step).

If charging is not necessary, then the controller 15 proceeds to step S113. In step S113, the controller 15 turns the first switch module 141 off (switch-off step).

When the external power source 22 is used to charge the second battery module 132, the controller 15 executes the flowchart of FIG. 3 (B). The voltage applied to the terminals 11a and 11b is higher than the voltage of the second battery module 132 and lower than the voltage across the first and second battery modules 131 and 132 connected together in series. In step S121, the controller 15 determines if it is necessary to charge the second battery module 132.

If charging is necessary, then the controller 15 proceeds to step S122. In step S122, the controller 15 turns the second switch module 142 on (switch-on step).

If charging is not necessary, then the controller 15 proceeds to step S123. In step S123, the controller 15 turns the second switch module 142 off (switch-off step).

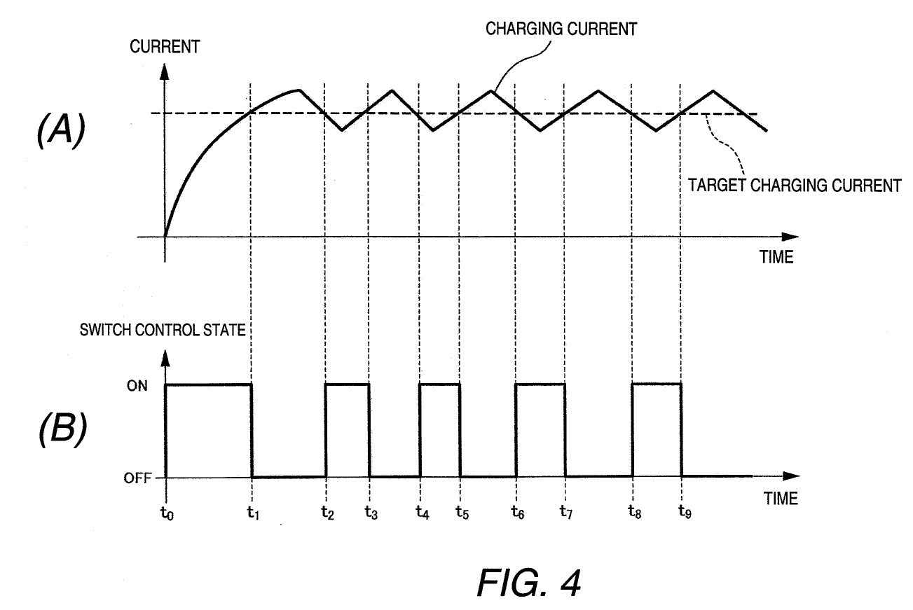

FIG. 4 is a time chart showing the states of the charging current and the switches when the flowcharts of FIGS. 3A and 3B are executed. In the following explanation, the step numbers of the flowcharts shown in FIGS. 3A and 3B are indicated in parentheses to illustrate the correspondence between the time chart and the flowcharts.

At a time t0 of FIG. 4, the controller 15 determines if it is necessary to charge the first battery module 131 (S111). As shown in graph (A) of FIG. 4, the charging current has not reached the target charging current and the controller 15 determines that it is necessary to charge the first battery module 131. As shown in graph (B) of FIG. 4, the controller 15 turns the first switch module 141 “on” (S112: switch-on step). Then, as shown in graph (A) of FIG. 4, the charging current flowing to the battery 131a gradually increases. The charging current increases gradually because the reactor 132b is connected in series with the battery 131a.

At a time t1 of FIG. 4, the charging current reaches the target charging current (see graph (A) of FIG. 4) and the controller 15 determines that it is not necessary to charge the first battery module 131 (result of step S111 is No). As shown in graph (B) of FIG. 4, the controller 15 turns the first switch module 141 “off” (step S113: switch-off step). The charging current then gradually decreases.

At a time t2 of FIG. 4, the charging current again falls below the target charging current (see graph (A) of FIG. 4) and the controller 15 determines that it is necessary to charge the first battery module 131 (result of step S111 is Yes). As shown in graph (B) of FIG. 4, the controller 15 turns the first switch module 141 “on” (step S113: switch-on step).

The controller 15 repeats the processing described above.

The target charging current can be a fixed value or it can be varied depending on the state of the battery. For example, it can be set to a larger value when the battery module is cooled so that the battery module can be charged more rapidly and set to a smaller value when the battery module is heated so that the load imposed on the battery can be lightened.

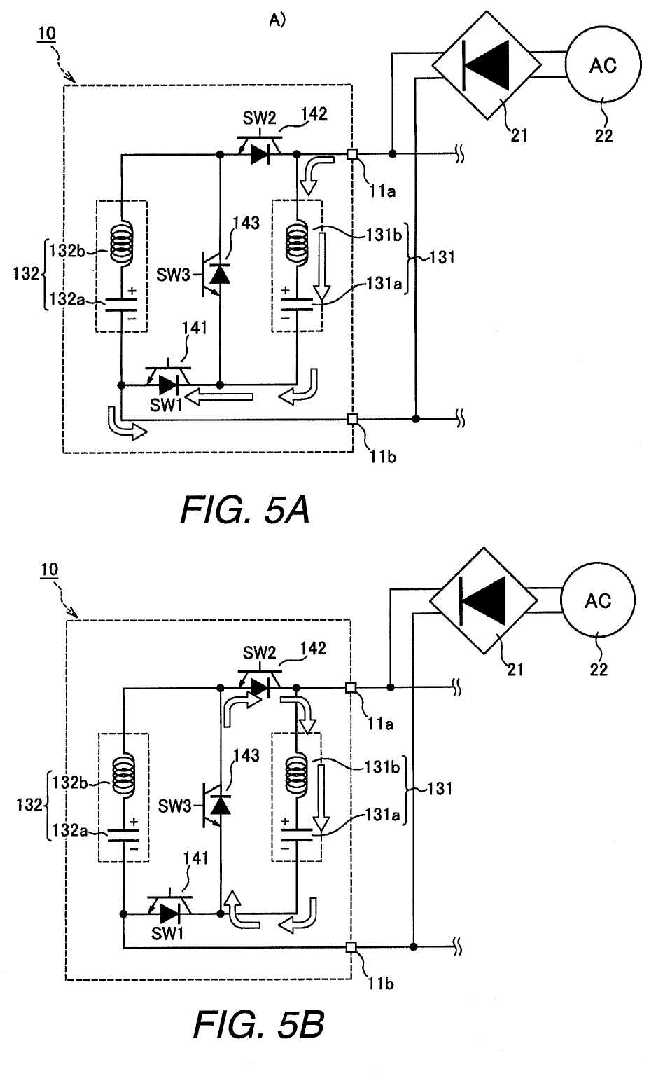

FIGS. 5A and 5B are simplified circuit diagrams illustrating the flow of current that occurs when the charging control described above is executed with respect to the first battery module 131.

When the first battery module 131 is charged using the external power source 22, the external power source 22 is connected to the terminals 11a and 11b through the rectifier 21. A voltage VE1 that is higher than the voltage of the first battery module 131 and lower than the voltage across the first and second battery modules 131 and 132 connected together in series is then applied to the terminals 11a and 11b. Next, the first switch module 141 is turned “on” (S112: switch-on step).

Since the applied voltage VE1 is higher than the voltage of the first battery module 131 (battery 131a), the internal current of the battery unit 10 flows through the components of the battery unit 10 in the following order, as shown in FIG. 5A: terminal 11a→first battery module 131 (reactor 131b→battery 131a)→first switch module 141→terminal 11b→rectifier 21. As a result, the first battery module 131 is charged. Since the first battery module 131 has a reactor 131b connected in series with the battery 131a, the current (charging current) passing through the first battery module 131 (battery 131a) increases gradually after the first switch module 141 is turned “on”.

When the charging current reaches the target charging current, the first switch module 141 is turned “off” (step S113: switch-off step). When the first switch module 141 is turned “off”, the first and second battery modules 131 and 132 are connected together in series through the third switch module 143.

Since the applied voltage VE1 is lower than the voltage across the first and second battery modules 131 and 132 connected in series, the flow of current from the external power source 22 is blocked and electric power stops being supplied to the battery unit 10. Since the first battery module 131 includes the reactor 131b, the current flowing from the first battery module 131 (reactor 131b→battery 131a) through the third switch module 143 and through the second switch module 142 (131→143→142→ . . . ) decreases gradually as shown in FIG. 5B.

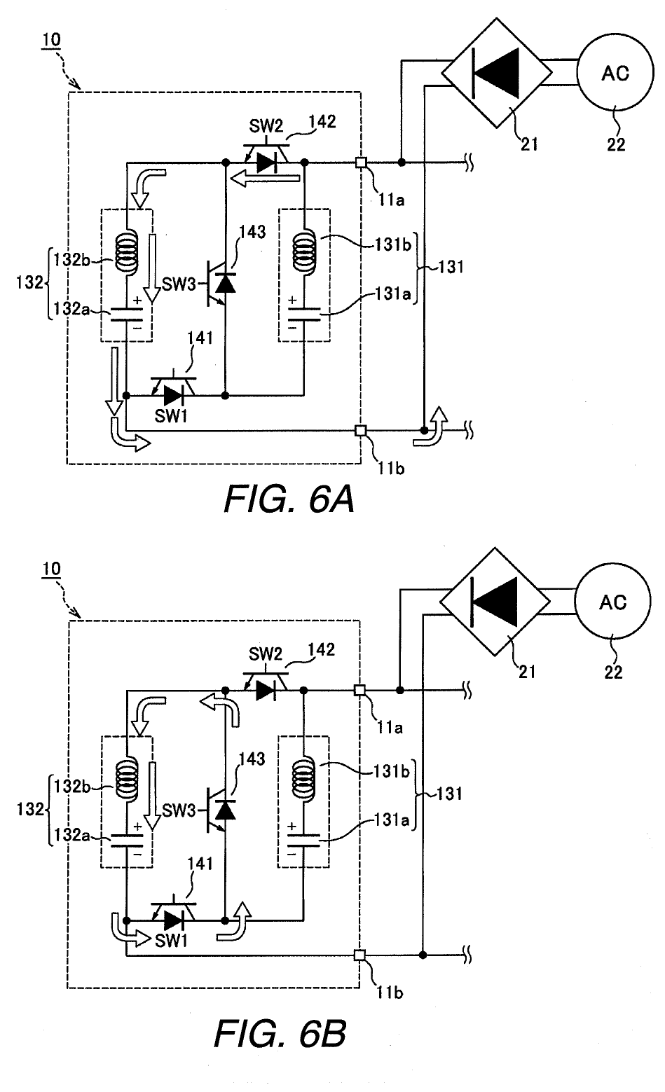

FIGS. 6A and 6B are simplified circuit diagrams illustrating the flow of current that occurs when the charging control described above is executed with respect to the second battery module 132.

When the second battery module 132 is charged using the external power source 22, the external power source 22 is connected to the terminals 11a and 11b through the rectifier 21. Then a voltage VE2 that is higher than the voltage of the second battery module 132 and lower than the voltage across the first and second battery modules 131 and 132 connected together in series is applied to the terminals 11a and 11b. Next, the second switch module 142 is turned “on” (S112: switch-on step).

Since the applied voltage VE2 is higher than the voltage of the second battery module 132 (battery 132a), the internal current of the battery unit 10 flows through the components of the battery unit 10 in the following order, as shown in FIG. 6A: terminal 11a→second switch module 142→second battery module 132 (reactor 132b→battery 132a)→terminal 11b→rectifier 21. As a result, the second battery module 132 is charged. Since, similarly to the first battery module 131, the second battery module 132 has a reactor 132b connected in series with the battery 132a, the current (charging current) passing through the second battery module 132 (battery 132a) increases gradually after the second switch module 142 is turned “on”.

When the charging current reaches the target charging current, the second switch module 142 is turned “off” (step S113: switch-off step). When the second switch module 142 is turned “off”, the first and second battery modules 131 and 132 are connected together in series through the third switch module 143.

Since the applied voltage VE2 is lower than the voltage across the first and second battery modules 131 and 132 connected in series, the flow of current from the external power source 22 is blocked and electric power stops being supplied to the battery unit 10. Since the second battery module 132 includes the reactor 132b, the current flowing from the second battery module 132 (reactor 132b→battery 132a) through the first switch module 141 and through the third switch module 143 (132→141→143→ . . . ) decreases gradually as shown in FIG. 6B.

As explained previously, this embodiment enables a current flowing to the first and second battery modules 131 and 132 to be controlled by controlling the on-off states of the first and second switch modules 141 and 142 contained inside the battery unit 10. In this way, the first and second battery modules 131 and 132 can be charged by controlling the internal switch modules 141 and 142. Additionally, since the reactor 131b and 132b are connected in series with each of the batteries 131a and 132a, respectively, the current changes gradually instead of rapidly and surge currents are prevented from occurring.

In this particular charging method, it is acceptable to simply use a diode as the third switch module 143 and omit the use of a transistor.

The explanation provided above describes a charging method in which the first and second battery modules 131 and 132 are each charged individually. However, if the voltage applied across the terminals 11a and 11b from the external power source is set to be higher than the voltage of the first battery module 131, higher than the voltage of the second battery module 132, and lower than the voltage across the first and second battery modules 131 and 132 connected in series, then the first and second battery modules 131 and 132 can be charged simultaneously by controlling the on-off states of both the first switch module 141 and the second switch module 142 at the same time so as to control the currents flowing to the first and second battery modules 131 and 132. Since the principle is the same, simultaneous charging is not illustrated in the drawings. However, the flow of current during this kind of charging will now be explained. If the first and second switch modules 141 and 142 are both turned “on” at the same time, then the first and second battery modules 131 and 132 will be connected in parallel with respect to the external power source and current will flow from the external power source to the first battery module 131 and to the second battery module 132, thereby charging the battery modules 131 and 132. If the first and second switch modules 141 and 142 are then both turned “off” at the same time, then the first and second battery modules 131 and 132 will be connected in series with respect to the external power source and current from the external power source will be blocked, thereby causing charting of the battery modules 131 and 132 to stop.

This embodiment is also applicable when the battery is discharged. By controlling the on-off state of the third switch module 143 in accordance with the discharge current flowing to the reactors 131b and 132b, the voltage at the input terminals of the inverter 31 can be controlled to any desired voltage.

In conventional battery unit systems, the circuitry for switching the connection state of the battery modules between series and parallel has required fuses and/or reactors to be provided between the battery modules and the inverter in order to suppress abnormal currents (surge currents) occurring due to the potential differences between the inverter and the battery modules being connected during the switch from series to parallel or parallel to series. Additionally, in order to charge the battery unit with an external power source, it has been necessary to have a separate charging apparatus that comprises a plurality of switches and reactors.

With the illustrated embodiment, as explained previously, the first and second battery modules 131 and 132 are provided with the reactors 131b and 132b, respectively, which are connected in series with the batteries 131a and 132a such that abnormal currents can be suppressed and voltages can be adjusted. Thus, by controlling the on-off states of the first and second switch modules 141 and 142 provided inside the battery unit 10, the current flowing to the first and second battery modules 131 and 132 can be controlled so as to charge the first and second battery modules 131 and 132. Consequently, it is not necessary to use a charging apparatus comprising switches and reactors. Additionally, since a reactor 131b and 132b is connected in series with each of the batteries 131a and 132a, the current changes gradually instead of rapidly and surge currents are prevented from occurring.

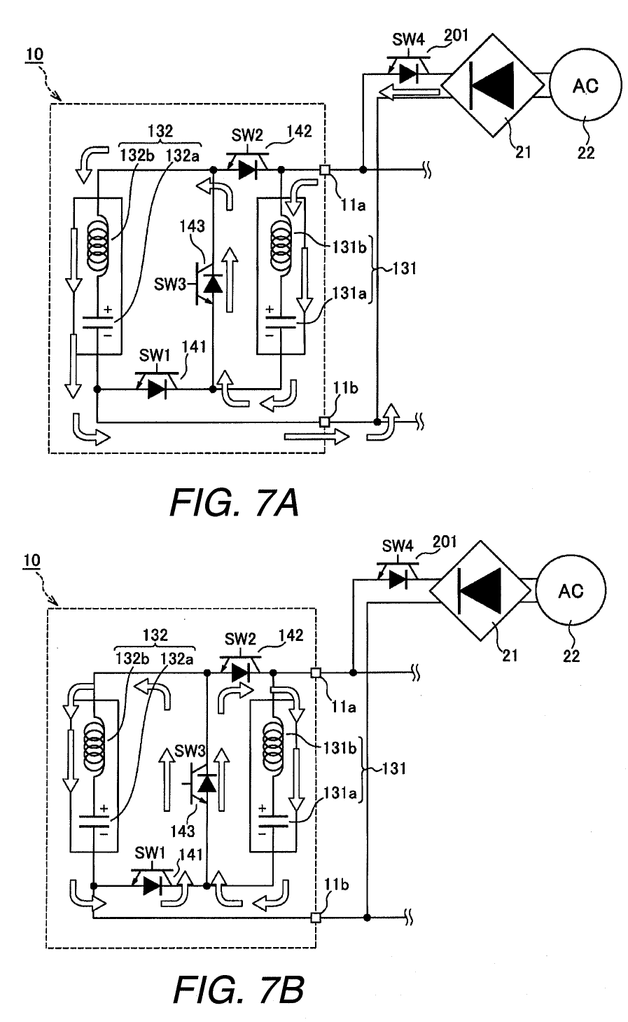

FIGS. 7A and 7B are simplified circuit diagrams illustrating the flow of current that occurs when the charging control is executed with respect to the first and second battery modules 131 and 132 using the external power source 22 while the voltage applied to the terminals 11a and 11b from the external power source 22 is set to a voltage that is higher than the voltage across the first and second battery modules 131 and 132 connected together in series. An example of such a case is when the voltage of the external power source 22 is 300 V, the voltage of the first battery module 131 is 140 V, and the voltage of the second battery module 132 is 140 V.

In this case, the battery unit 10 is connected to the external power source 22 through a charging switch 201 and a rectifier 21 and the battery unit 10 is charged using the external power source 22. The charging switch 201 constitutes a fourth switch module that is controlled by the controller 15.

When the first and second battery modules 131 and 132 are charged using the external power source 22, the external power source 22 is connected to the terminals 11a and 11b through the charging switch 201 and the rectifier 21. A voltage VE3 that is higher than the voltage across the first and second battery modules 131 and 132 connected together in series is then applied to the terminals 11a and 11b. Next, the charging switch 201 is turned “on” (voltage applying step).

Since the applied voltage VE3 is higher than the voltage across the first battery unit 131 and the second battery unit 132 connected together in series (i.e., higher than the series voltage of the battery 131a and the battery 132a), the internal current of the battery unit 10 flows through the components of the battery unit 10 in the following order, as shown in FIG. 7A: terminal 11a→first battery module 131 (reactor 131b→battery 131a)→third switch module 143→second battery module 132 (reactor 132b→battery 132a)→terminal 11b→rectifier 21. As a result, the first and second battery modules 131 and 132 are charged. Additionally, since each of the battery modules 131 and 132 has a reactor connected in series with the battery, the current (charging current) passing through the battery modules (batteries) increases gradually after the charging switch 201 is turned “on”.

When the target charging current is reached, the charging switch 201 is turned “off” and the voltage application from the external power source 22 stops (voltage application stopping step). When the charging switch 201 is turned “off”, the internal currents of the battery unit 10 gradually decrease while flowing through the components of the battery unit 10 in the following orders, as shown in FIG. 7B: first battery module 131 (reactor 131b→battery 131a)→third switch module 143→second switch module 142, and second battery module 132 (reactor 132b→battery 132a)→first switch unit 141→third switch module 143.

As explained previously, by controlling the on-off state of the charging switch 201 that controls whether or not the voltage is applied to the battery unit 10, the current flowing to the first and second battery modules 131 and 132 can be controlled such that the first and second battery modules 131 and 132 are charged simultaneously. Additionally, since a reactor 131b and 132b is connected in series with each of the batteries 131a and 132a, the current changes gradually instead of rapidly and surge currents are prevented from occurring.

In this particular charging method, it is acceptable to simply use a diode for each of the first switch module 141, the second switch module 142, and the third switch module 143 and omit the use of a transistor.

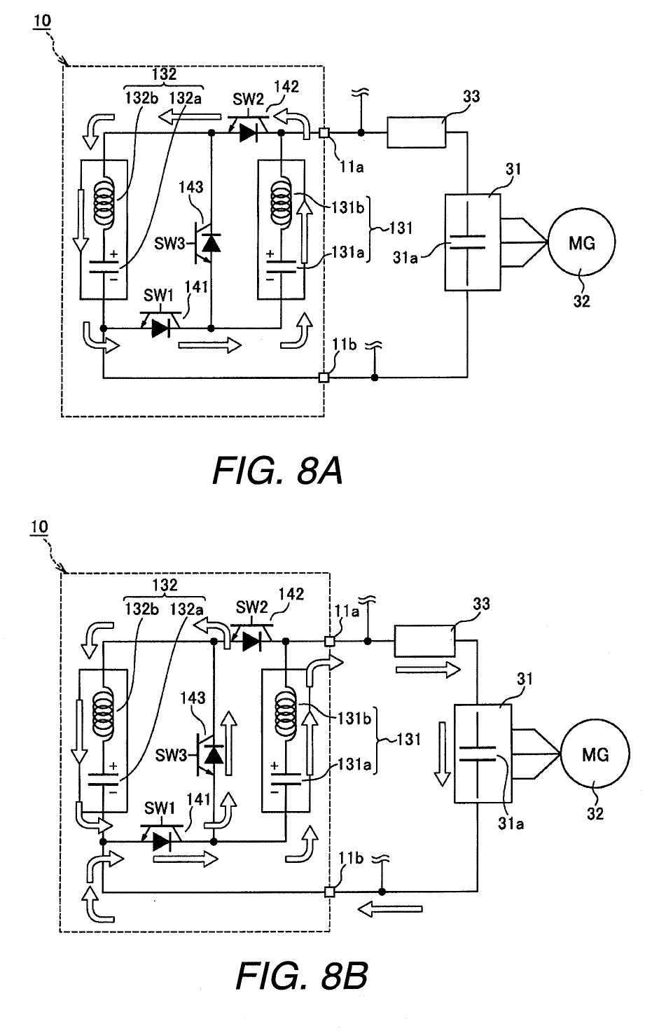

FIGS. 8A and 8B are simplified circuit diagrams illustrating the flow of current that occurs when a voltage variation correction control in accordance with the present invention is executed in order to correct voltage variation among the battery modules of the battery unit 10.

Even if the first and second battery modules 131 and 132 are made to the same specifications, the characteristics thereof can differ slightly due to manufacturing variations and the difference in the characteristics can cause variation to exist in the voltages of the battery modules. A control serving to correct this kind of voltage variation will now be explained.

When the voltage of the first battery module 131 is higher than the voltage of the second battery module 132, the contactor 33 is first turned “on” and the capacitor 31a is connected to the terminals 11a and 11b. Then, the second switch module 142 is turned “on” (switch-on step). After the second switch module 142 is turned “on”, a current flows through the internal components of the battery unit 10 in the following order, as shown in FIG. 8A: first battery module 131 (battery 131a→reactor 131b)→second switch module 142→second battery module 132 (reactor 132b→battery 132a)→first switch module 141. Additionally, since each of the battery modules 131 and 132 has a reactor connected in series with the battery, the current (charging current) passing through the battery modules (batteries) increases gradually after the second switch module 142 is turned “on”.

Next, the second switch module 142 is turned “off” (switch-off step) and, as shown in FIG. 8B, the current exiting the first battery module 131 (battery 131a→reactor 131b) flows as follows: terminal 11a→contactor 33→inverter 31→(capacitor 31a)→terminal 11b→first switch module 141→first battery module 131. Meanwhile, the current exiting the second battery module 132 (reactor 132b→battery 132a) flows as follows: first switch module 141→third switch module 143→second battery module 132.

Next, the second switch module 142 is turned “on” again (switch-on step) and the current flows as shown in FIG. 8A. By turning the second switch module 142 on and off in this fashion, electric charge can be transferred from the first battery module 131 (whose electric potential is higher) to the second battery module 132 (whose electric potential is lower) and the state of the voltage of the first battery module 131 being higher than the voltage of the second battery module 132 can be corrected.

When the voltage of the second battery module 132 is higher than the voltage of the first battery module 131, the voltage difference can be corrected in a similar manner by controlling the on-off state of the first switch module 141. Thus, voltage variation between the battery modules of the battery unit 10 can be corrected by merely controlling the on-off states of the first switch module 141 or the second switch module 142 contained inside the battery unit 10.

The battery module voltage variation correction control described above can also be executed when the inverter 31 and the motor generator 32 are being controlled for the generation of electricity. The voltage variation (difference) between the first and second battery modules 131 and 132 can be corrected by controlling the on-off state of the first switch module 141 or the second switch module 142 in accordance with the size relationship between the voltages of the battery modules 131 and 132.

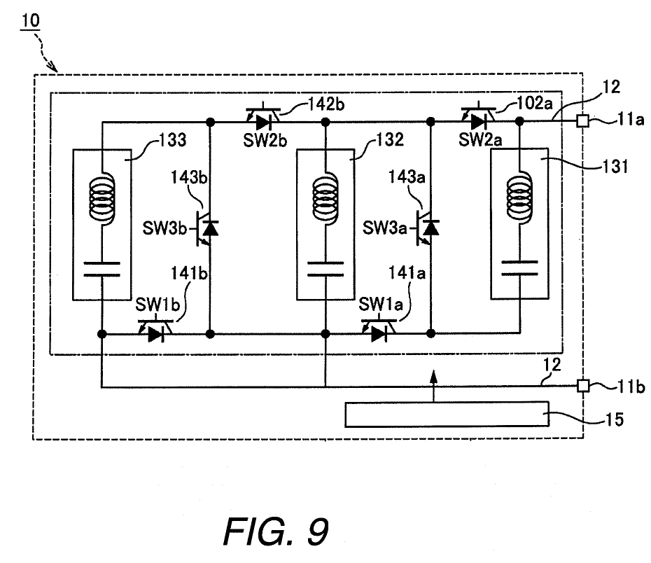

Referring now to FIG. 9, a battery unit 110 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The first embodiment illustrates an example in which the battery unit 10 has two battery modules in order to make the main aspects of the invention easier to understand. However, a similar control can be accomplished with respect to the battery unit 110 having three battery modules as shown in FIG. 9. More specifically, in a situation where the first switch module 141 would be controlled if the battery unit 10 had two battery modules, the first switch modules 141a and 141b of the battery unit 110 with three battery modules is similarly controlled. Similarly, in a situation where the second switch module 142 would be controlled if the battery unit had two battery modules, the second switch modules 142a and 142b of the battery unit 110 with three battery modules is similarly controlled. In a situation where the third switch module 143 would be controlled if the battery unit had two battery modules, the third switch modules 143a and 143b of the battery unit having three battery modules is similarly controlled. In this way, the battery unit 110 with three battery modules (as shown in FIG. 9) can be controlled in a similar manner to a battery unit having two battery modules. Expanding on this idea, a similar control can be accomplished with respect to a battery unit having four or more battery modules.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A battery unit comprising:
a positive electrode terminal;
a negative electrode terminal;
a first battery module connected to the positive and negative electrode terminals, and including a first battery and a first reactor connected together in series;
a second battery module connected in parallel with the first battery module, and including a second battery and a second reactor connected together in series;
a first switch module arranged between the negative electrode terminal and a negative electrode side of the first battery module;
a second switch module arranged between a positive electrode side of the first battery module and a positive electrode side of the second battery module;
a bypass line connecting a point lying between the first battery module and the first switch module to a point lying between the second battery module and the second switch module;
a third switch module arranged in the bypass line; and
a controller operatively arranged to selectively control an on-off state of each of the first, second and third switch modules.

2. The battery unit as recited in claim 1, wherein
the first switch module includes a first diode arranged to allow a flow of electric current from the negative electrode terminal to the negative electrode side of the first battery module, and a first switch arranged to selectively connect and disconnect a flow of electric current from the negative electrode side of the first battery module to the negative electrode terminal;
the second switch module includes a second diode arranged to allow a flow of electric current from the positive electrode side of the second battery module to the positive electrode side of the first battery module, and a second switch arranged to selectively connect and disconnect a flow of electric current from the positive electrode side of the first battery module to the positive electrode side of the second battery module; and
the third switch module includes a third diode arranged to allow a flow of electric current from the negative electrode side of the first battery module to the positive electrode side of the second battery module, and a third switch arranged to selectively connect and disconnect a flow of electric current from the positive electrode side of the second battery module to the negative electrode side of the first battery module.

3. The battery unit as recited in claim 2, wherein
the controller selectively connecting and disconnecting at least one of the first and second switches arranged in a corresponding one of the first and second battery modules to be charged while a charging voltage is applied to the battery unit, when a charging voltage applied across the positive and negative electrode terminals is higher than a voltage of the one of the first and second battery modules to be charged and lower than a voltage across the battery modules connected in series.

4. The battery unit as recited in claim 3, wherein
the controller includes a current sensor arranged to detect an electric current flowing in at least one of the first and second battery modules,
the controller connecting the one of the first and second switches when the electric current flowing in the one of the first and second battery modules to be charged is smaller than a target charging current, and
the controller disconnecting the one of the first and second switches when the electric current flowing in the one of the first and second battery modules to be charged is larger than the target charging current.

5. The battery unit as recited in claim 2, further comprising
a fourth switch operatively controlled by the controller, and
the controller selectively connecting and disconnecting the fourth switch while a charging voltage is applied to the battery unit, when a charging voltage applied across the positive and negative electrode terminals is higher than a voltage of one of the first and second battery modules to be charged and higher than a voltage of the battery modules connected in series.

6. The battery unit as recited in claim 5, wherein
the controller includes a current sensor arranged to detect an electric current flowing in at least one of the first and second battery modules,
the controller applying a voltage when the electric current flowing in the one of the first and second battery modules to be charged is smaller than a target charging current; and
the controller stopping the voltage when the electric current flowing in the one of the first and second battery modules to be charged is larger than a target charging current.

7. The battery unit as recited in claim 2, wherein
the controller selectively connecting and disconnecting one of the first and second switches arranged in a corresponding one of the first and second battery modules having a low voltage while a capacitor is connected to the positive and negative electrode terminals.

8. A battery unit comprising:
positive electrode terminal means for connecting to an external device;
negative electrode terminal means for connecting to the external device;
first electric power storing means, connected to the positive and negative electrode terminals, for storing electric power;
first current suppressing means, connected in series with the first electric power storing means, for suppressing rapid current changes with respect to the first electric power storing means;
second electric power storing means, connected in parallel with the first electric power storing means, storing electric power;
second current suppressing means, connected in series with the second electric power storing means, for suppressing rapid current changes with respect to the second electric power storing means;
first switch means for selectively connecting and disconnecting a flow of electric current between the negative electrode terminal means and a negative electrode side of the first electric power storing means;
second switch means for selectively connecting and disconnecting a flow of electric current between a positive electrode side of the first electric power storing means and a positive electrode side of the second electric power storing means;
electrical bypass means for electrically connecting a point lying between the first electric power storing means and the first switch means to a point lying between the second electric power storing means and the second switch means;
third switch means for selectively connecting and disconnecting a flow of electric current in the electrical bypass means; and
controller means for controlling an on-off state of each of the first, second and third switch means.
